(19) United States
(12) Patent Application Publication
(10) Pub. No.: US 2006/0180535 A1
(43) Pub. Date: Aug. 17, 2006

(54) Fuel supply unit with filter self-cleaning features

(75) Inventors: DeQuan Yu, Ann Arbor, MI (US); Paul Fisher, Brighton, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/056,202

(22) Filed: Feb. 11, 2005

(51) Int. Cl. B01D 29/00

(52) U.S. Cl. 210/172; 210/409; 210/416.4

(57) ABSTRACT

An in-tank fuel supply unit self cleans the mesh filter of the primary fuel pump, thereby permitting smaller mesh sizes to decrease pump wear and increase the life of the pump. Generally, the in-tank fuel supply unit includes a reservoir, an auxiliary fuel pump, a primary fuel pump and a filter. Fuel exiting the auxiliary fuel pump outlet is directed towards the filter to wash debris from the filter. Preferably a swirling flow is generated within the reservoir, or the system in run in an overflow condition to assist in the self cleaning of the fuel filter.

### FIELD OF THE INVENTION

The present invention relates generally to a fuel supply unit for a motor vehicle, and more particularly relates to an in-tank fuel supply unit.

### BACKGROUND OF THE INVENTION

In-tank fuel supply units are commonly referred to as a fuel delivery module (FDM) that is adapted to hold a portion of the tank fuel inside a reservoir of the FDM. The purpose of the reservoir is to keep the pump inlet submerged under all operating conditions, such as when the vehicle is parked on an incline or cornering with an almost empty tank, which could otherwise expose the pump inlet. A primary fuel pump is provided for pumping the fuel in the reservoir and providing it to the engine. Generally, the fuel pump sits inside the FDM and includes an inlet proximate the bottom of the reservoir which has a mesh filter attached thereto.

Unfortunately, when the gasoline contains a significant amount of contaminants, the debris can clog the primary pump's mesh filter, thereby reducing the output and efficiency of the pump. To solve this problem, typical designs employ bigger mesh size of the fuel filter to reduce a change of plugging the filter, with a known tradeoff of passing more contaminations through the pump, thereby increasing the pump wear and reducing the pump life.

### BRIEF SUMMARY OF THE INVENTION

The present invention provides an in-tank fuel supply unit which self cleans the mesh filter of the primary fuel pump, thereby permitting smaller mesh sizes to decrease pump wear and increase the life of the pump. Generally, the in-tank fuel supply unit includes a reservoir, an auxiliary fuel pump, a primary fuel pump and a filter. The reservoir is positioned inside the fuel tank for holding a supply of fuel. The auxiliary fuel pump provides fuel to the reservoir from the fuel tank. The auxiliary fuel pump has an auxiliary fuel pump outlet delivering fuel to the interior of the reservoir. The primary fuel pump provides fuel to the engine from the reservoir and has a primary fuel pump inlet positioned inside the reservoir. A filter is positioned to filter fuel in the reservoir prior to the fuel entering the primary fuel pump inlet. Fuel exiting the auxiliary fuel pump outlet is directed towards the filter to wash debris from the filter.

According to more detailed aspects, the filter may take the form of a mesh filter connected directly to the fuel pump inlet. In this case, the fuel supply unit preferably includes a guide channel formed adjacent the auxiliary fuel pump outlet which extends from the outlet towards the mesh filter. The guide channel may be curved to create a swirling flow inside the reservoir, and preferably extends circumferentially about 30-90 degrees. The guide channel may be formed by guide walls projecting from a wall of the reservoir, or may be separately formed and attached to the primary fuel pump.

According to even more detailed aspects, the auxiliary fuel pump may be integrally formed with the primary fuel pump as a pump unit having a primary pumping channel and an auxiliary pumping channel. Alternatively, the auxiliary fuel pump may be separately formed, preferably as a jet pump. The jet pump is typically positioned external to the reservoir and includes a mix tube extending into the reservoir and defining the auxiliary fuel pump outlet. The axis of the mix tube is preferably directed towards the mesh filter, and may also be curved to create the swirling flow inside of the reservoir.

According to still more detailed aspects, the filter may take the form of a screen covering an open upper end of the reservoir. In this case, the auxiliary fuel pump preferably takes the form of a jet pump having a mix tube defining the auxiliary fuel pump outlet. The auxiliary fuel pump outlet is positioned above the screen, while a deflector cap redirects fuel from the auxiliary fuel pump outlet towards the screen. Additionally, the fuel supply unit is structured to run in an overflow condition wherein the auxiliary fuel pump is run at a flow rate higher than a flow rate at which the primary fuel pump is run. The fuel overflowing from the reservoir cleans debris from the screen.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a cross-sectional view of an in-tank fuel supply unit constructed in accordance with the teachings of the present invention;

FIG. 2 is a plan view of a cover of a pump unit forming a portion of the fuel supply unit depicted in FIG. 1;

FIG. 3 is a cross-sectional view of the fuel supply unit taken about line 3-3 in FIG.1;

FIG. 4 is a cross-sectional view of an alternate embodiment of an in-tank fuel supply unit constructed in accordance with the teachings of the present invention;

FIG. 5 is cross-sectional view of yet another embodiment of an in-tank fuel supply unit constructed in accordance with the teachings of the present invention;

FIG. 6 is an enlarged cross-sectional view of the jet pump depicted in FIG. 5.

FIG. 7 is a cross-sectional view of the in-tank fuel supply unit taken about line 7-7 in FIG. 5; and

FIG. 8 is a cross-sectional view of still yet another embodiment of an in-tank fuel supply unit constructed in accordance with the teachings of the present invention.

### DETAILED DESCRIPTION OF THE INVENTION

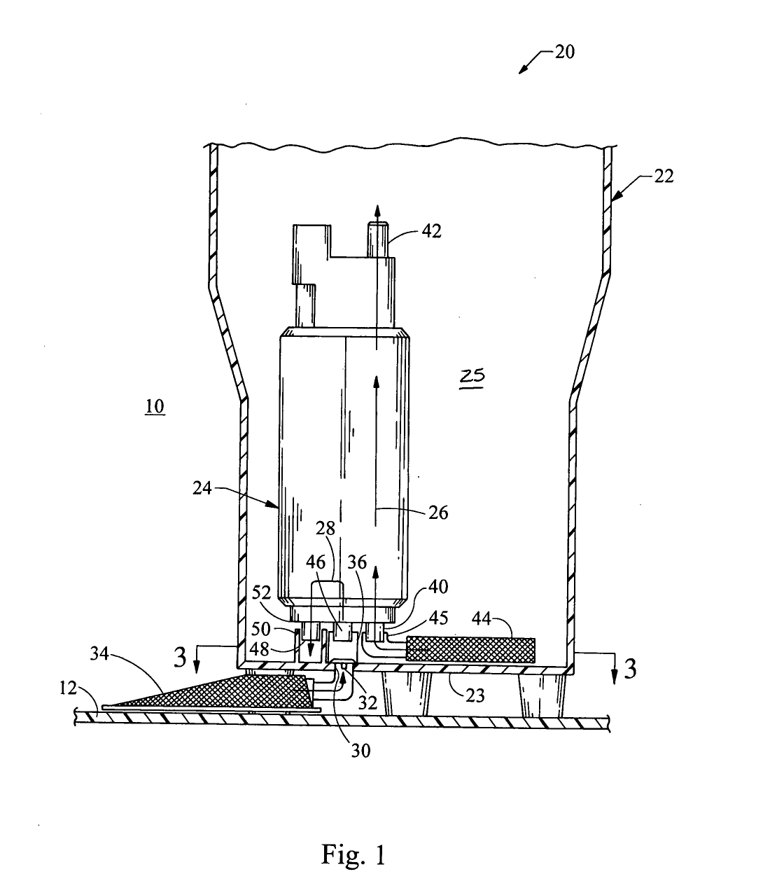

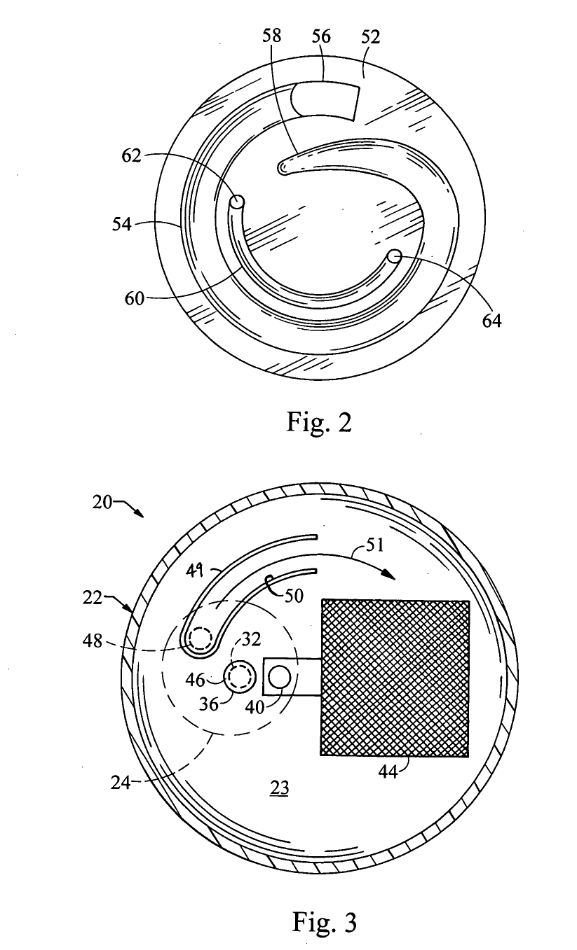

Turning now to the figures, FIGS. 1-3 depict an embodiment of an in-tank fuel supply unit 20 that is positioned inside a fuel tank 10 and resting on a bottom wall 12 of the tank 10. The fuel supply unit 20 generally includes a reservoir 22 positioned inside the fuel tank 10 for holding a supply of fuel. A pump unit 24 is positioned inside the reservoir 22. The pump unit 24 generally includes a primary fuel pump indicated by flow line 26, and an auxiliary fuel pump generally indicated by flow line 28. As shown in FIG. 2, a cover 52 of the pump unit 24 includes a primary pumping channel 54 and an auxiliary pumping channel 60. The primary pumping channel 54 includes a primary channel inlet 56 and a primary channel outlet 58. Likewise, the auxiliary pumping channel 60 includes an auxiliary channel inlet 62 and an auxiliary channel outlet 64. As is known in the art, the pump unit 24 includes an impeller or other like device which pressurizes flow through the primary and auxiliary pumping channels 54, 56. It will be recognized by those skilled in the art that other types of liquid pumps 24 may be utilized in accordance with the teachings of the present invention.

Turning to FIG. 1, the pump unit 24 generally includes a primary fuel pump inlet 40 that is fluidically connected to the primary channel inlet 56 of the cover 52, and a primary fuel pump outlet 42 fluidically connected to the primary channel outlet 58. The primary fuel pump outlet 42 is typically connected to a hose or other conduit to deliver fuel to the engine of the motor vehicle. The pump unit 24 also includes an auxiliary fuel pump inlet 46 fluidically connected to the auxiliary pumping channel inlet 62 and an auxiliary fuel pump outlet 48 fluidically connected to the auxiliary pumping channel outlet 64. As is known in the art, the reservoir 22 includes a flapper valve 32 positioned within an opening 30 formed in the reservoir 22, through which fuel from the tank 10 may enter the reservoir 22, while preventing fuel in the reservoir 22 from leaking back into the tank 10. Connector 36 fluidically links the opening and flapper valve 30, 32 with the auxiliary fuel pump inlet 46. A first-stage filter 34 is attached to the opening and flapper valve 30, 32, such that the auxiliary fuel pump 28 draws fuel from the tank 10, through the filter 34, through the opening and flapper valve 30, 32 in through the auxiliary fuel pump inlet 46 and out through the auxiliary fuel pump outlet 48 into the interior 25 of the reservoir 22.

The fuel supply unit 20 also includes a mesh filter 44 that is connected to the primary fuel pump inlet 45. As previously discussed, a mesh filter can become clogged with debris or other contaminations. Accordingly, the fuel exiting the auxiliary fuel pump outlet 48 is directed towards the filter 44 to provide self-cleaning of the same. As best seen in FIG. 3, the fuel supply unit 20 includes a guide channel 50 which is positioned adjacent the auxiliary fuel pump outlet 48 for directing the flow of fuel 51 exiting the auxiliary fuel pump outlet 48. The guide channel 50 is formed as a portion of the bottom wall 23 of the reservoir 22 by an elongated projection 49 extending upwardly from the bottom wall 23. It will be recognized that the guide channel 50 may also be formed by a plurality of projections 49 and may take many shapes and forms.

As shown in FIG. 3, the guide channel 50 is preferably curved in shape as it extends towards the pump filter 44 and is preferably curved in the range of 30 to 90 degrees (circumferentially). The curved guide channel 50 thus creates a swirling flow 51 in the reservoir 22. This swirling flow 51 assists in removing debris from the filter 44 and keeping contaminations around the outer periphery of the reservoir 22. As shown in FIG. 1, the projection 49 defining the guide channel 50 may extend upwardly to a point just below the pump unit 24 but axially overlapping the auxiliary fuel pump outlet 48. However, it will be recognized that the projecting walls 49 of the guide channel 50 may engage the pump unit 24, either at its cover 52 or at the auxiliary pump outlet 48, or at some other portion. As shown in FIG. 3, the guide channel 50 is preferably upwardly opening, although the open upper side of the channel 50 may be closed off to provide further guidance to the fuel exiting the auxiliary fuel pump 28.

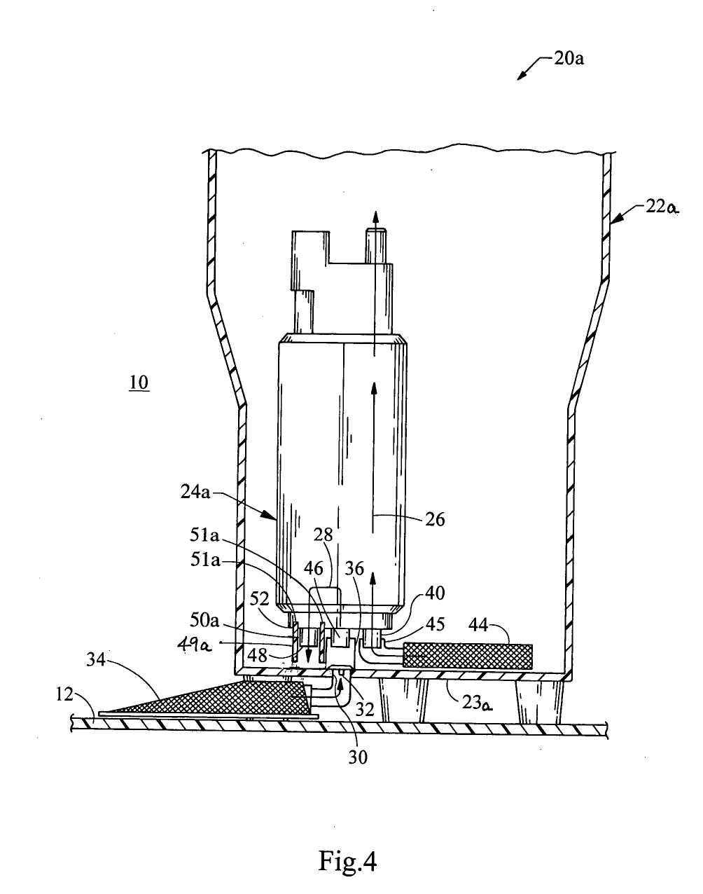

Another embodiment of an in-tank fuel supply unit 28 has been depicted in FIG. 4 and is fairly similar to the embodiment depicted in FIGS. 1-3. Accordingly, common reference numerals have been used on FIG. 4 with differing parts having reference numerals followed by a small letter “a”. The fuel supply unit 20a includes a slightly modified guide channel 50a. In this embodiment, the projecting walls 49a of the guide channel 50a are separately formed from the reservoir 22a and connected directly to the pump unit 24a. Accordingly, the pump unit 24a preferably includes slots 51a or other receiving features that permit the walls 49a of the guide channel 50a to be connected directly to the pump unit 24a. As in the prior embodiment, the projecting walls 49a may extend downwardly to engage the bottom wall 23a of the reservoir 22a, or may stop short of engaging the bottom wall 23a. In either case, the guide channel 50a is structured in a curved shape such as is shown in FIG. 3, and directs fuel from the auxiliary fuel pump 20a towards the primary pump filter 44 to clean debris from the same, and preferably creates a swirling flow within the reservoir 22a.

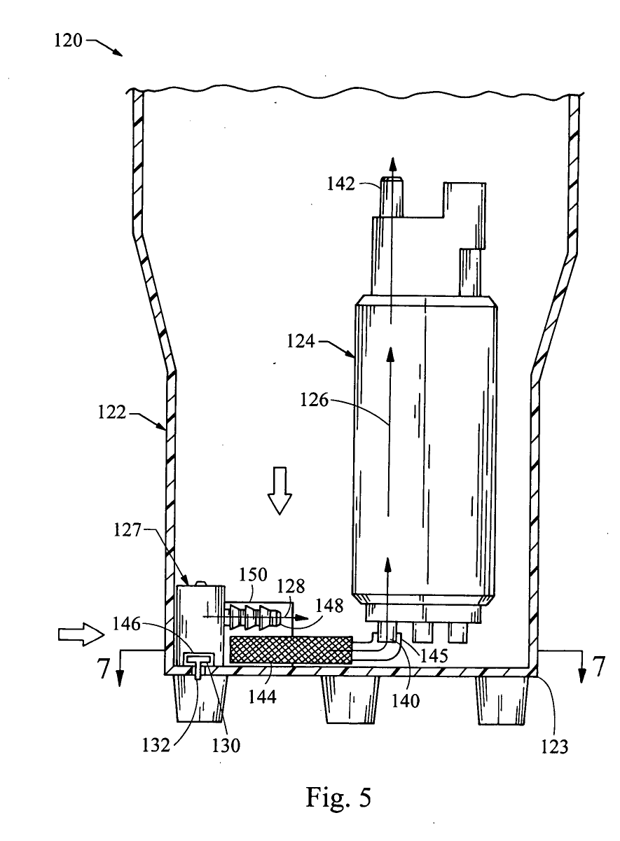

Another embodiment of an in-tank fuel supply unit 120 is depicted in FIGS. 5-7. As in the prior embodiments, the fuel supply unit 120 generally includes a reservoir 122 having a bottom wall 123 supporting a pump unit 124 therein. Here, the pump unit 124 comprises only the primary fuel pump as represented by flow line 126. A jet pump 127 is separately formed and provides the auxiliary fuel pump represented by flow line 128. The jet pump 127 may be positioned inside the reservoir 122, or alternatively may be attached to the outer periphery of the reservoir 122, as is known in the art. The primary pump 124, 126 generally includes a primary fuel pump inlet 140 and a primary fuel pump outlet 142. The primary fuel pump inlet 140 is connected to a mesh filter 144 by way of a connecting portion 145.

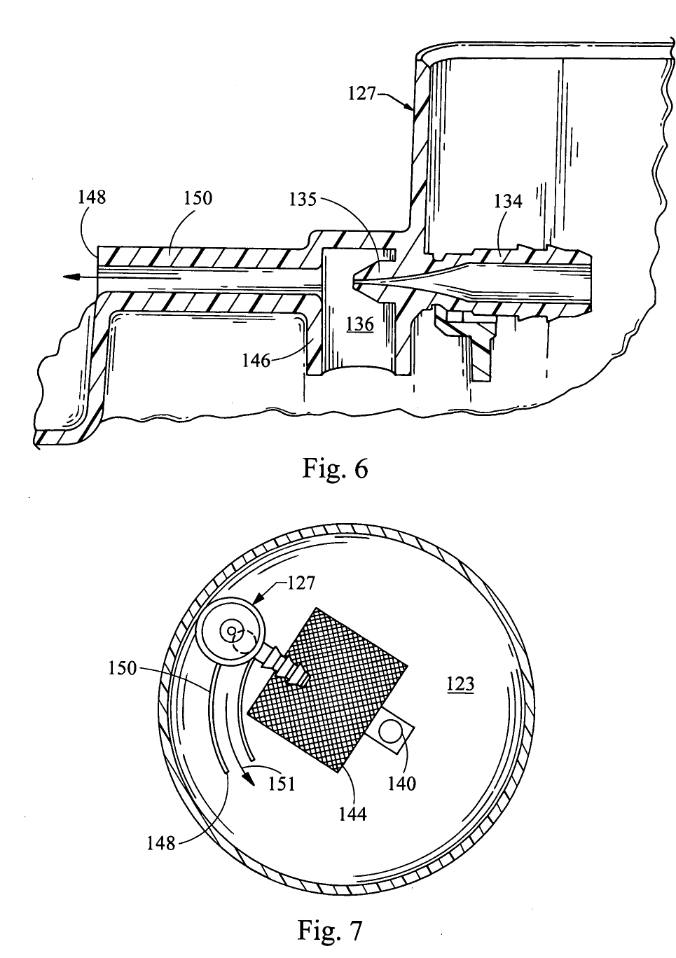

The reservoir 122 includes an aperture 130 having a flapper valve 132 fitted therein for permitting fuel to enter the reservoir 122 from the fuel tank. The jet pump 127 includes a suction tube 146 fluidically connected to the opening 130 and flapper valve 132, as best seen in FIG. 6. One embodiment of a jet pump 127 is depicted in FIG. 6, although numerous designs may be employed in conjunction with the teachings of the present invention, as jet pumps and their designs are well know in the art. The jet pump 127 generally includes a nozzle body 134 having a nozzle tip 135 through which high velocity fuel is sprayed. The fuel exiting the nozzle tip 135 thus creates a vacuum which draws fuel up through a suction tube 136. Accordingly, the jet pump 127 sucks fuel from the bottom of the fuel tank through the aperture and flapper valve 130, 132. The fuel exiting the nozzle 134 is mixed with the suctioned fuel and mixes therewith in mix tube 150. Mix tube 150 includes a distal end defining the auxiliary pump outlet 148.

As best seen in FIG. 7, the mix tube 150 essentially serves to guide the fuel exiting the jet pump 127. Accordingly, the mix tube 150 and auxiliary fuel pump outlet 148 are positioned adjacent the mesh filter 144 connected to the primary fuel pump inlet 140. As with the prior embodiments, the mix tube 150 is preferably arcuate in shape and spans circumferentially in the range of 30-90 degrees, although smaller or larger spans are readily envisioned an encompassed by the present invention. In this manner, the mesh filter 144 is cleaned by the fuel exiting the auxiliary jet pump 127 via the auxiliary fuel pump outlet 148, and the swirling flow of fuel in the reservoir 122.

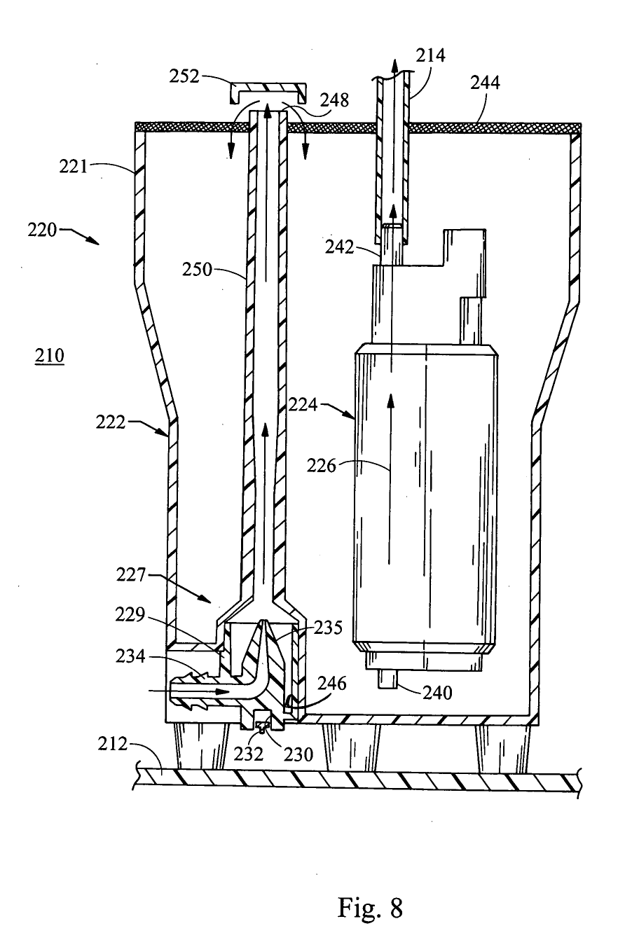

Turning to FIG. 8, still yet another embodiment of an in-tank fuel supply unit 220 has been depicted. As in the prior embodiments, the fuel supply unit 220 is positioned inside a fuel tank 210 and supported on a bottom wall 212 of the tank 210. The fuel supply unit 220 generally includes a reservoir 222 containing a primary fuel pump 224 for providing a flow of fuel 226 to the engine of a motor vehicle. The primary pump 224 includes a primary fuel pump inlet 240 and a primary fuel pump outlet 242 which has been shown attached to a supply conduit 214. The reservoir 222 includes an open upper end 221. A screen 244 is positioned at the open upper end 221 for filtering fuel entering the reservoir 222, as will be described in more detail below.

The auxiliary fuel pump 227 again takes the form of a jet pump having an auxiliary fuel pump inlet 234 and an auxiliary fuel pump outlet 248. The nozzle body 234 is provided with pressurized fuel which is directed through a nozzle 235. An aperture 230 and flapper valve 232 allow fuel to enter an auxiliary fuel pump inlet 246 from the bottom of the reservoir 222. As previously discussed, the high velocity fuel exiting the nozzle 235 creates a vacuum drawing fuel up through the auxiliary fuel pump inlet 246, and the two fuel flows are mixed in mix tube 250. As in the prior embodiment, the mix tube 250 defines the auxiliary fuel pump outlet 248, although in this embodiment the outlet 248 is positioned above the open upper end 221 and screen 244. A deflector cap 252 is positioned above the auxiliary fuel pump outlet 248 to redirect fuel exiting the outlet back downwardly toward the screen 244 and into the reservoir of 222. In this manner, fuel exiting the auxiliary fuel pump 227 is directed towards the screen 244 and cleans debris from the same.

An additional self-cleaning feature is also provided in this embodiment. The auxiliary fuel pump 227 is set to run at a flow rate higher than the flow rate at which the primary fuel pump 224 is set to run. Thus, the fuel supply unit 222 is structured to run in an overflow condition. As fuel in the reservoir 222 overflows out the upper open end 221, the overflow will remove debris from an upper side of the screen 244. As previously discussed, fuel exiting the auxiliary fuel pump outlet 248 (and directed by deflector cap 252) serve to clean debris from both the upper and lower sides of the screen 244.

Accordingly, it will be recognized by those skilled in the art that the teachings of the present invention provide an in-tank fuel supply unit that can take many forms, all of which self-clean the filter of the primary fuel pump. The primary filter may be a mesh filter connected directly to the fuel pump, or may be a screen affixed at the top of the reservoir. By directing flow from the auxiliary fuel pump outlet towards the primary filter, as well as creating a swirling flow within the reservoir or running the system in an overflow condition, the primary pump filter is self-cleaning and permits use of smaller mesh sizes and a reduction of contaminants to the primary fuel pump. In this way, pump wear may be decreased and the life of the fuel pump will be beneficially increased.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An in-tank fuel supply unit for delivering fuel to an engine of a motor vehicle from a fuel tank, the fuel supply unit comprising:
a reservoir positioned inside the fuel tank for holding a supply of fuel;
a primary fuel pump for providing fuel for the engine, the primary fuel pump having a primary fuel pump inlet positioned inside the reservoir;
a mesh filter connected to the primary fuel pump inlet;
an auxiliary fuel pump for providing fuel to the reservoir from the fuel tank, the auxiliary fuel pump having an auxiliary fuel pump outlet delivering fuel to the interior of the reservoir, fuel exiting the auxiliary fuel pump outlet being directed towards the mesh filter to clean the mesh filter.

2. The fuel supply unit of claim 1, further comprising a guide channel formed adjacent the auxiliary fuel pump outlet, the guide channel extending from the auxiliary fuel pump outlet and towards the mesh filter.

3. The fuel supply unit of claim 2, wherein the guide channel is curved to create a swirling flow of fuel inside the reservoir.

4. The fuel supply unit of claim 3, wherein the guide channel extends circumferentially about 30 to 90 degrees.

5. The fuel supply unit of claim 2, wherein the guide channel is formed by guide walls projecting from a wall of the reservoir.

6. The fuel supply unit of claim 2, wherein the guide channel is separately formed and attached to the primary fuel pump.

7. The fuel supply unit of claim 1, wherein the auxiliary fuel pump and primary fuel pump are integrally formed in a pump unit having a primary pumping channel and an auxiliary pumping channel.

8. The fuel supply unit of claim 1, wherein the auxiliary fuel pump is a jet pump.

9. The fuel supply unit of claim 8, wherein the jet pump is positioned external to the reservoir.

10. The fuel supply unit of claim 8, wherein the jet pump includes a mix tube defining the auxiliary fuel pump outlet.

11. The fuel supply unit of claim 10, wherein the axis of the mix tube is directed towards the mesh filter.

12. The fuel supply unit of claim 10, wherein the mix tube is curved to create a swirling flow of fuel inside the reservoir.

13. An in-tank fuel supply unit for delivering fuel to an engine of a motor vehicle from a fuel tank, the fuel supply unit comprising:
a reservoir positioned inside the fuel tank for holding a supply of fuel, the reservoir having an open upper end;
a screen covering the open upper end of the reservoir;
a primary fuel pump for providing fuel for the engine, the primary fuel pump having a primary fuel pump inlet positioned inside the reservoir;
an auxiliary fuel pump for providing fuel to the reservoir from the fuel tank, the auxiliary fuel pump comprising a jet pump having a mix tube defining an auxiliary fuel pump outlet delivering fuel to the interior of the reservoir, the auxiliary fuel pump outlet being positioned above the screen; and
the fuel supply unit structured to run in an overflow condition wherein the auxiliary fuel pump is run at a flow rate higher than a flow rate at which the primary fuel pump is run, fuel overflowing from the reservoir cleaning debris from the screen.

14. The fuel supply unit of claim 13, wherein fuel exiting the auxiliary fuel pump outlet being directed towards the screen to clean debris from the screen.

15. The fuel supply unit of claim 13, further comprising a deflector cap positioned above the auxiliary fuel pump outlet to deflect fuel downwardly towards the screen.

16. An in-tank fuel supply unit for delivering fuel to an engine of a motor vehicle from a fuel tank, the fuel supply unit comprising:
a reservoir positioned inside the fuel tank for holding a supply of fuel;
an auxiliary fuel pump for providing fuel to the reservoir from the fuel tank, the auxiliary fuel pump having an auxiliary fuel pump outlet delivering fuel to the interior of the reservoir,
a primary fuel pump for providing fuel for the engine, the primary fuel pump having a primary fuel pump inlet positioned inside the reservoir;
a filter filtering fuel in the reservoir prior to the fuel entering the primary fuel pump inlet;
fuel exiting the auxiliary fuel pump outlet being directed towards the filter to wash debris from the filter.

17. The fuel supply unit of claim 16, wherein the filter is a screen positioned at open upper end of the reservoir, and wherein the auxiliary fuel pump is a jet pump having a mix tube defining the auxiliary fuel pump outlet, the auxiliary fuel pump outlet being positioned above the screen.

18. The fuel supply unit of claim 17, wherein the fuel supply unit is structured to run in an overflow condition wherein the auxiliary fuel pump is run at a flow rate higher than a flow rate at which the primary fuel pump is run, fuel overflowing from the reservoir cleaning debris from the screen.

19. The fuel supply unit of claim 16, wherein the filter is a mesh filter connected to the primary fuel pump inlet, and further comprising a guide channel formed adjacent the auxiliary fuel pump outlet, the guide channel extending from the auxiliary fuel pump outlet and towards the mesh filter, the guide channel being curved to create a swirling flow of fuel inside the reservoir.

20. The fuel supply unit of claim 16, wherein the auxiliary fuel pump is one of a jet pump and a pump integrally formed with the primary fuel pump as a pump unit.
